(19) United States
(12) Patent Application Publication
(10) Pub. No.: US 2005/0238571 A1
(43) Pub. Date: Oct. 27, 2005

(54) Process and apparatus for the production of alumina

(76) Inventors: Benny E. Raahauge, Copenhagen (DK); William S. Maley, Mandurah (AU)

Correspondence Address: Daniel DeJoseph;Legal Department, 2040 Avenue C, Bethlehem, PA, 18017-2188, US

(21) Appl. No.: 10/831,863

(22) Filed: Apr. 26, 2004

(51) Int. Cl. C01F 7/02

(52) U.S. Cl. 423/625

(57) ABSTRACT

A process for the production of alumina from aluminum trihydrate in which the trihydrate is dried and pre-heated, after which the remaining free and chemically-bonded water is removed when the trihydrate is converted by calcination to form hot calcined alumina which is cooled to about 50-100° C. in one or more stages. In at least one stage the hot calcined alumina is cooled in a countercurrent cyclone

This invention relates to a process for the production of alumina from aluminum trihydrate in which the trihydrate is dried and pre-heated, after which the remaining free and chemically-bonded water is removed when the trihydrate is converted by calcination to alumina and finally cooled to about 50-100° C. in two stages, where the calcined alumina through at least one stage is suspended in a gas and a cyclone that is utilized in the process.

### BACKGROUND OF THE INVENTION

The expression aluminium hydrate is used in trade and industry in reference to aluminum hydroxides. Various types of hydroxides are known, but the most well-defined crystalline forms are trihydrates, Al₂(OH)₃, gibbsite (α-Al₂(OH)₃), bayerite (β-Al₂(OH)₃), and nordstrandite.

The Bayer Process—an economical method of producing aluminium oxide—was discovered by an Austrian chemist Karl Bayer and patented in 1887.

The process dissolves the aluminium component of bauxite ore in sodium hydroxide (caustic soda); removes impurities from the solution; and precipitates alumina trihydrate which is then calcined to aluminium oxide. The final stage in the production of alumina by the Bayer process is the calcination of aluminium trihydrate:
Al₂(OH)₃+energy→Al₂O₃₊₃H₂O

Calcined alumina is normally produced from gibbsite, and this trihydrate is converted by thermal decomposition to α-alumina, α-Al₂O₃ (corundum).

Calcination has traditionally been carried out in a rotary kiln so that both dehydration and recrystallisation take place continually in the kiln. The finished calcined product can then be partially cooled in a planetary cooler and this may be followed by cooling in a unit with a water-cooled fluid bed.

It is also known that calcination can take place in a fluid bed and in such an installation the primary cooling of the material will normally take place in a multiple-stage cyclone cooler with three to five stages, where the primary cooling can be followed by a secondary cooling stage, for instance in a water-cooled fluid bed.

Since about 1980 the use of a GSC—Gas Suspension Calciner—has been well known in the industry for the calcination of aluminium hydrate (see for example GB Patent no. 2097903). FIG. 1 illustrates an installation of this type. FIG. 1 also shows the traditional method of cooling the alumina through the use of a plurality of cooling cyclones. Four cyclones, set forth as 15a, 15b, 15c and 15d, are depicted. Typically, the cyclones utilized will include a vertically situated upper cylindrical portion. The gas stream enters the upper cylindrical portion tangentially in a generally horizontal direction. The hollow housing will further include a lower portion. The tangential entry of the gas stream into the hollow upper housing converts the linear gas flow into a downwardly spiraling, rotating vortex in a generally helical direction relative to a vertical central axis of the cyclone. The swirling action of the vortex causes the particles in the gas stream within the vortex to be moved to an outer region by the centrifugal force exerted by the swirling action of the vortex. There is an interaction of vortex flow which results in a continuous upward cleaned gas flow toward a cleaned gas outlet mounted generally at the top of the upper cylindrical housing portion. Typically, the cleaned gas outlet is a tube or pipe mounted in the center of the upper cylindrical portion. Thus as the vortex moves downwardly within the lower housing portion particles within the gas stream are moved outwardly toward the inside housing wall of the cyclone and downwardly through an exit at the lower portion of the housing.

In the production of alumina it is important that the breakdown of the alumina particles should as far as possible be minimized, since the breakdown of the particles leads to finer pulverization of the particles, which thus causes the development of dust and the resulting problems in handling the material.

It has been seen that particle breakdown is relatively great during the heat exchange process in multiple-stage cyclone coolers, and thus necessitates the production of stronger and larger-grained particles of hydrate, entailing further investment costs which have limited the cost-effectiveness of the use of fluid beds and GSC, which otherwise prove to be the most compact installations, require the least energy and are the most economical to install. It would be advantageous, therefore, to reduce the number of cyclone coolers utilized in the production of alumina.

### DESCRIPTION OF THE INVENTION

The invention according to this application demonstrates a process for the production of alumina where the cooling of the calcined alumina in at least one stage is carried out in a countercurrent cyclone in which the cold gas creates a spirally-formed stream from the gas inlet to the gas outlet, in that the cooling gas is introduced tangentially into the countercurrent cyclone through the outer casing of the cyclone and is discharged through an opening close to the horizontal axis of the cyclone. The process is notable in that the countercurrent cyclone, as described in more detail below, will replace at least two, and at times all, of the cooling cyclones used in the prior art process.

In the present invention, the hot alumina is fed into the countercurrent cyclone close to and parallel with its horizontal axis, but radially displaced in relation to the axis, and is discharged through the base cone of the countercurrent cyclone.

A countercurrent cyclone of this type can wholly or partially replace a multiple-stage cyclone having three or more cyclone stages with the result that particle breakdown is considerably reduced while the full effect of the heat transfer is maintained and at the same time a better separation of the gas from the material is achieved. Furthermore, as a result of the very simple design of the countercurrent cyclone, it will be more economical to build an installation with a countercurrent cyclone.

A type of countercurrent cyclone suitable for this application is described in two Danish patents, No. 160586 and No. 161786. A countercurrent cyclone of this type has proved to give a minimal particle breakdown and extremely good heat transfer.

### DESCRIPTION OF THE DRAWINGS

FIG. 1 illustrates a prior art installation for the production of alumina.

FIG. 2 illustrates an installation for carrying out a process according to the invention.

FIG. 3 illustrates another embodiment of an installation for carrying out a process according to the invention.

FIG. 4 is a partial side cut-away view of a “countercurrent” cyclone used in the process of the present invention.

FIG. 5 is a full side view, with the gas inlet being shown in relief, of a “countercurrent” cyclone used in the process of the present invention.

FIG. 6 is a top view of a “countercurrent” cyclone used in the process of the present invention.

FIG. 7 is a full side view of a conical “countercurrent” cyclone used in the process of the present invention.

FIG. 8 is a full side view of a standard “countercurrent” cyclone used in the process of the present invention, with the material inlet and gas outlet being shown.

In the drawings, similar numerals refer to similar elements.

### DETAILED DESCRIPTION OF EMBODIMENTS OF THE INVENTION

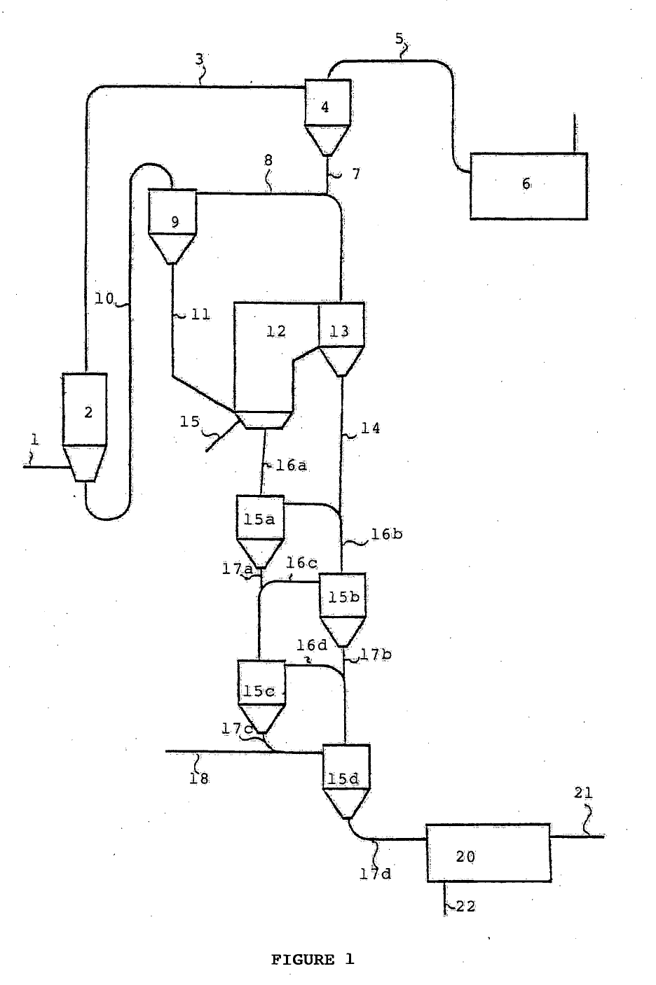

FIG. 1 illustrates a prior art installation for the production of alumina. Aluminum trihydrate is introduced at 1 into a drying unit 2. The drying unit 2 may by way of example be a flash drier. As the hydrate is dried and heated up it will become suspended in a gas and will be led via duct 3 to the first pre-heating cyclone 4. The gas in which the hydrate is suspended is hot process gas from second stage pre-heating cyclone 9 which is introduced via duct 10.

In the pre-heating cyclone the dried and pre-heated material is separated from the gas and the gas is led via a duct 5 to be cleaned in a unit 6 which by way of example may be an electrofilter. The material is led via duct 7 into a hot gas flow (0-100° C. cooler than the temperature the material is subject to in calciner 12) and is then led in suspension through duct 8 to a further pre-heating cyclone 9, in which the material is separated from the gas and led via duct 11 to the calciner 12. The gas is led via duct 10 to the drying unit as previously stated.

Calciner 12 in this example is a GSC—a Gas Suspension Calciner—in which the material will remain for a few seconds. In calciner 12 the material is heated to approximately 900-1500° C., and preferably to between approximately 1100-1200° C., by means of the burning of gaseous or liquid fuel, which is introduced at 15, and the material is then led further in suspension with carrier gas introduced into the calciner via duct 16a to the separating cyclone 13 where the material is separated from the carrier gas and led via duct 14 to the cooler. The separated gas is led via duct 8 first to a pre-heating cyclone 9 and then to drying unit 2.

In this prior art system the primary cooling unit consists of a multiple-stage cyclone cooler with four stages, illustrated as cyclones 15a, 15b, 15c and 15d, with riser pipes 16b, 16c and 16d. The material is introduced into the first cyclone 15a via a gas duct 16b and in the cyclone the material is separated from the gas and led via duct 17a to gas duct 16c. The gas, which has a temperature of approximately 600-800° C., is led via duct 16a to the base of the calciner 12.

The material which is suspended in the gas in gas duct 16c is led to cyclone 15b. From there the gas is led via duct 16b and the separated material is transported via duct 17b to a gas duct 16d, where it is again suspended in a gas and led to the third cyclone 15c.

From cyclone 15c the material is led via duct 17c to a gas duct 18, through which cold air is transported to the primary cooling unit and through this duct the material is carried in suspension to the last cyclone 15d, after which the gas is led to the third cyclone via duct 16d and the material is led via duct 17d to the secondary cooling unit 20. A convenient type of secondary cooling unit 20 is the fluid bed type to which cold gas is led via duct 22 and where the finished product is discharged for storage or for further processing via duct 21.

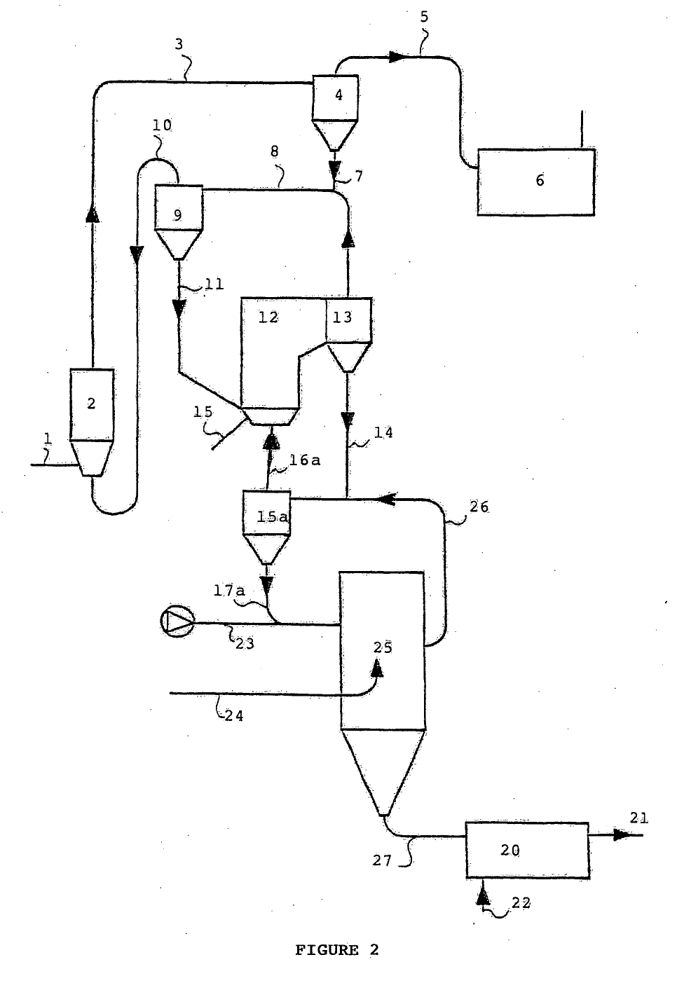

FIG. 2 illustrates an installation in which the flows between the drying unit 2, the pre-heating cyclones 4 and 9 and between the calciner 12 and the separating cyclone 13 are identical with the flows described and illustrated in FIG. 1.

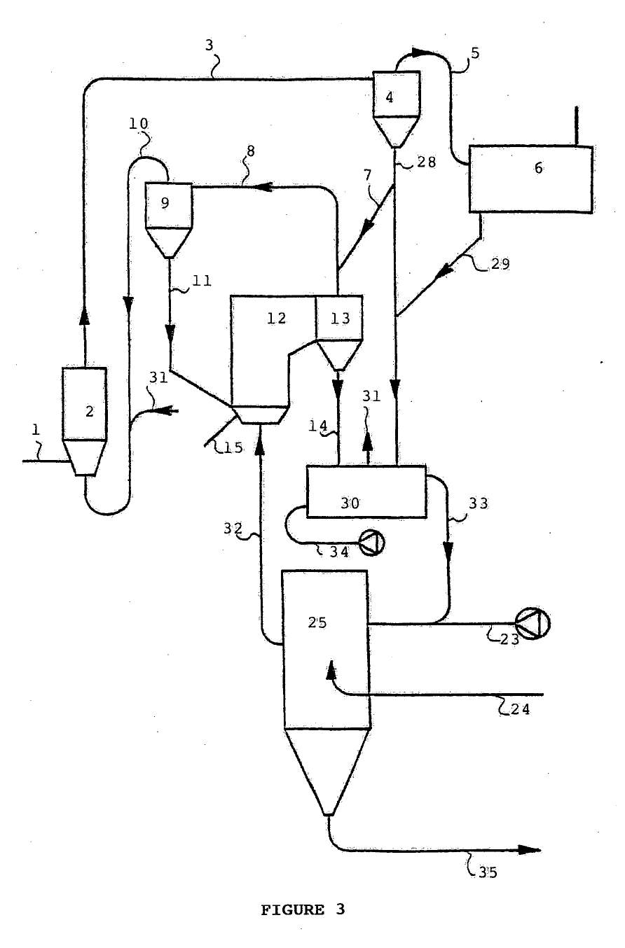

Referring now to FIGS. 2 and 3, the material which is separated from the gas in separating cyclone 13 is led via duct 14 into a gas flow of pre-heated gas in which the material is suspended, and this suspension is then introduced into cyclone 15a via duct 26. In cyclone 15a the material is separated from the gas and the material is led via duct 17a into a gas flow in which the material is suspended and the suspension is thereafter introduced into a countercurrent cyclone 25 via duct 23. Duct 23 leads the suspension of gas and material into the central section of the countercurrent cyclone 25 close to the horizontal axis A-A′ of the cyclone. In the cyclone the material is cooled to a temperature of between about 180° and 300° C. The material is driven outwards by centrifugal force towards the cyclone casing, is led out through the base of the cyclone and transferred via duct 27 to a secondary cooling unit 20, in which the material is cooled to a temperature of between about 50° and 100° C.

The hot alumina material is introduced into the cyclone parallel with, but radially dispersed from, the horizontal axis A-A′ of the countercurrent cyclone and in such a manner that immediately on introduction the hot alumina possesses a tangential velocity component in relation to the axis of the countercurrent cyclone, and that this velocity component rotates in the same direction around the axis as the spirally-formed cold gas flow and thereafter the material is transported for a time by said cold gas flow.

Cold gas for cooling the material is introduced into the countercurrent cyclone through duct 24. This duct 24 directs the cold gas flow tangentially into the cyclone and the gas forms a spiral flow inwards toward the cyclone axis A-A′, where there is a discharge outlet for the gas now pre-heated by heat transfer with the hot material. The pre-heated gas is then led forward via duct 26 to cyclone 15a.

FIG. 3 illustrates an installation which is equipped with a possible means of directing part of the hydrate, that normally would all be directed to calciner 12, via a bypass to first cooling stage 30. An adjustable amount of the material which leaves the pre-heating cyclone 4 is sent directly via duct 28 to first cooling stage 30. The remainder of the material which leaves cyclone 4 is led via duct 7 across to gas duct 8, where it is brought into suspension and led to the calciner 12 via pre-heating cyclone 9. FIG. 3 also illustrates directly sending the preheated gas directly from countercurrent cyclone 25 to calciner 12 via duct 32, rather than sending the gas first through preliminary cooler 15a, as is the case in the embodiment of FIG. 2.

The gas which is led away from the pre-heating cyclone 4 is sent to be cleaned, for instance in an electrofilter. The dust which settles out in cleaning unit 6 can then be led to the cooling system via duct 29, which leads the dust to material duct 7.

In the installation of FIG. 3, the calcined material passes, unlike the installations illustrated in FIGS. 1 and 2, via duct 14 to a first cooling unit 30. In this case the first cooling unit 30 is of the fluid bed type and material reaches it via ducts 14 and 7, while the cooled material leaves the unit via duct 33 and pre-heated gas is led via duct 31 to duct 10, through which the heated gas is led further to the drying unit 2. The cooled material is led via duct 33 into a gas duct 23, where the material is brought into suspension and led into the countercurrent cyclone 25 close to its horizontal axis. The material is then driven outwards by centrifugal force towards the cyclone casing, and is led out through the base of the cyclone via duct 35.

Cold gas for cooling the material is introduced into the countercurrent cyclone through duct 24. This duct 24 directs the cold gas flow tangentially into the cyclone and the gas forms a spiral flow inwards toward the cyclone axis, where there is a discharge outlet for the now pre-heated gas. The pre-heated gas is then led forward via duct 32 to the calciner 12.

The term “counter current” cyclone (hereafter alternatively “CCC”) as utilized herein is exemplified by cyclone 60 as illustrated in FIGS. 4-8. Referring to FIG. 4, a cyclone separator generally designated as 60 includes a hollow housing of a tubular or barrel configuration generally designated as 41 for receiving a flowing cooling gas stream moving upwardly in the direction of arrows 42 through an inlet duct 43. The hollow housing 41 includes an upper generally cylindrical portion 44 which is mounted in cooperation with the inlet duct 43 for receiving the gas stream which enters the upper cylindrical portion 44 tangentially and moving initially in an upper direction. The hollow housing 41 further includes a lower, frustro-conical portion 45 which is mounted under the upper cylindrical portion 44 by any suitable means. The upwardly directed, tangential entry of the gas stream into the upper portion 44 converts the linear gas flow into a laterally spiraling, rotating vortex rotating in a generally helical direction about horizontal axis A-A′. Housing 41 may be entirely cylindrical if desired, the principal structural requirement being that the housing 41 receive the gas stream entering duct 43 and cooperate therewith to convert such gas stream into a vortex moving in the direction shown by arrows 46. Particles to be cooled will enter the cyclone through a side wall 47 via inlet 48 located close to horizontal axis A-A′ of cyclone 60 and essentially near the center or inner region 49 of vortex 46. The swirling action of vortex 46 causes the particles in the gas stream within vortex 46 to be moved to an outer vortex region 51 close to side wall 55 of cyclone 60. The movement of the particles or particulate in vortex 46 into outer region 51 thereof is caused by the centrifugal force exerted by the swirling action of vortex 46. The segregation of particles into outer vortex region 51 leaves gas substantially freed of particles within the inner region 49 of vortex 46.

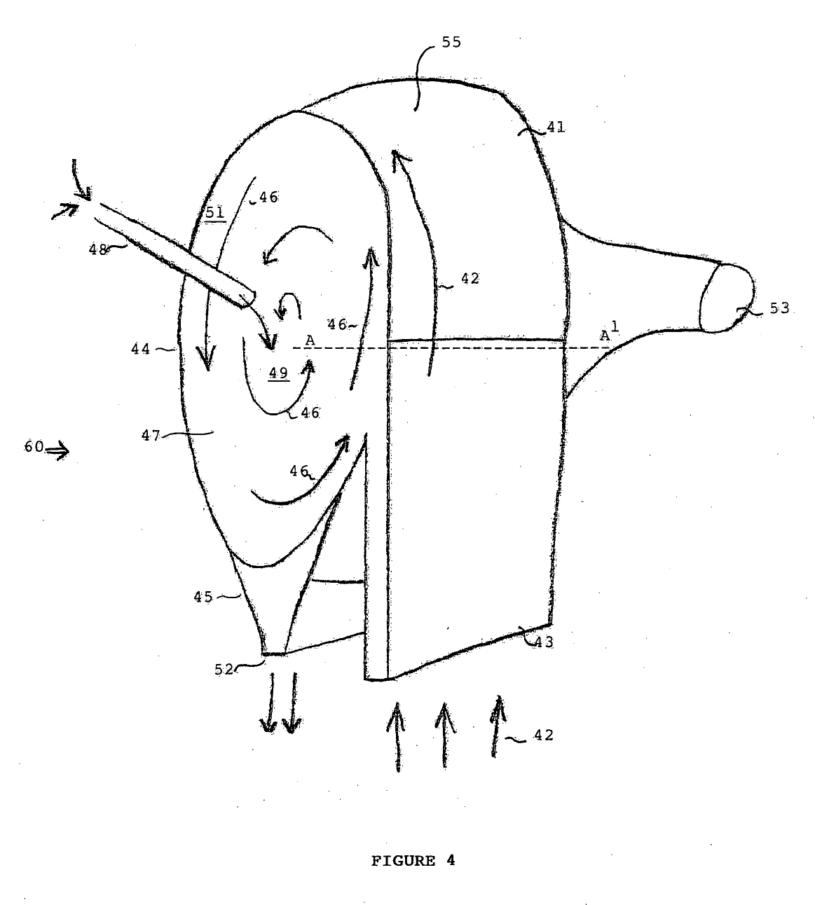

As indicated, in traditional cyclones material enters the cyclone tangentially into the vertical wall of the cyclone and therefore first encounters the outermost portion of the swirling vortex. In the CCC utilized in the present invention, cooling gas enters cyclone 60 tangentially but in an upward direction through gas inlet 43. Thus, cooling gas swirls in a generally helical direction relative to a horizontal central axis of the cyclone. The hot material is delivered into the center of swirling vortex 46 of the cooling gas and therefore will have to work its way to outer vortex region 51 resulting in the material spending more time, relative to a traditional cyclone, in contact with the cooling gas. Depending on the velocity of the gas, cooled material above a predetermined weight will fall by gravity through material exit 52. Gas heated from contact with the hot material and any entrained material too light to fall by gravity through the swirling air within the cyclone will exit through gas outlet 53 which is located close to horizontal axis A-A′ in sidewall 54 (shown in FIG. 5) of cyclone 60 opposite sidewall 47.

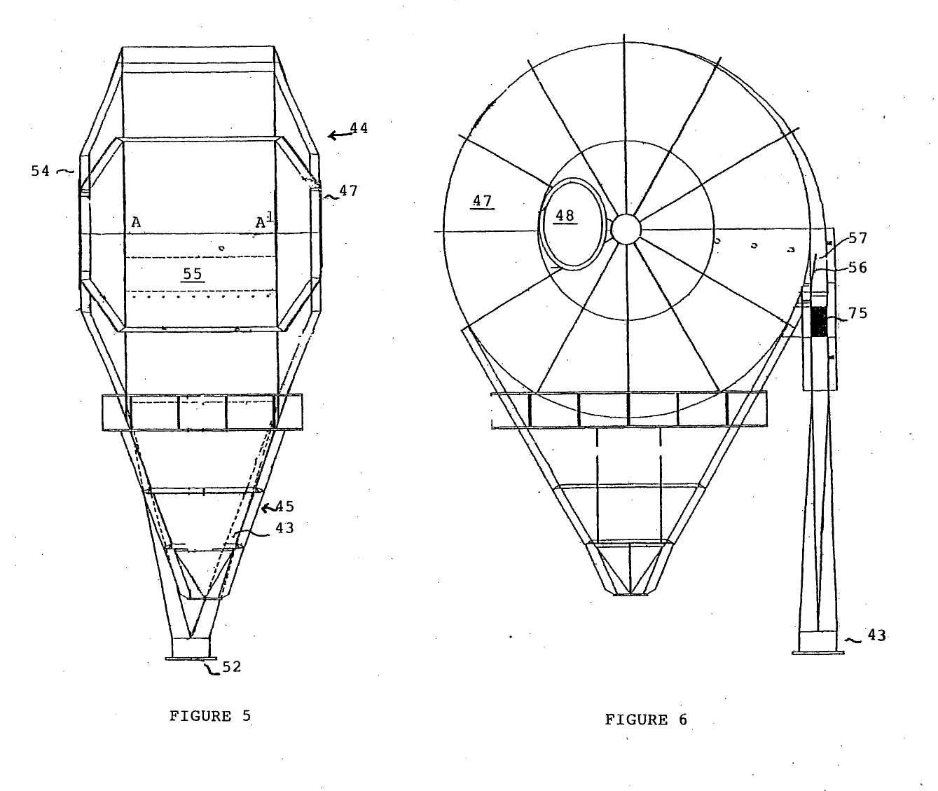

FIGS. 5 and 6 illustrate modifications to the cyclone used in the present invention. Baffle plate 55 (shown in relief) is mounted horizontally and is positioned so that material entering cyclone 60 will strike baffle plate 55 and will be more evenly distributed throughout the interior of cyclone 60. In addition, FIG. 6 depicts movable gas velocity adjustment plate 75 which is situated within gas inlet 43. The plate acts like an adjustable venturi, regulating at that site the size of the gas opening (not shown) within gas inlet 43, and serves to give the operator the ability to regulate the velocity of cooling gas entering the cyclone. Movable plate 75 serves to adjust the direction of air flow in the interior of cyclone 60.

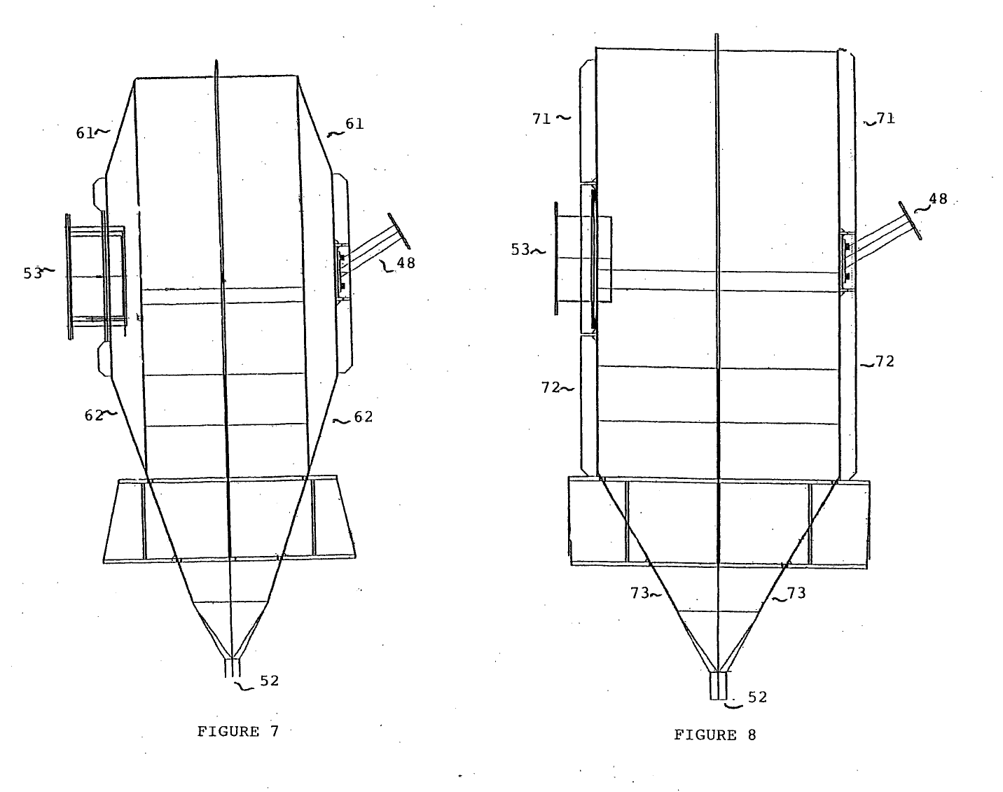

Tests were run utilizing both a primarily “conical” shaped CCC and a “standard” shaped CCC. The conical CCC of the present invention, as depicted in FIG. 7, has conical shaped sidewalls 61, 62 on opposite lateral sides of the cyclone 60. The conical side walls each include an upper portion 61 above the material inlet 48 and gas outlet 53 and a lower portion 62 below the inlet 48 and outlet 53.

The standard CCC of the present invention, as depicted in FIG. 8, has upper standard shaped sidewalls 71 located above material inlet 48 and gas outlet 53 and lower standard shaped sidewalls 72 and lower conical shaped sidewalls 73. Obviously, in the “standard” CCC depicted in FIG. 8, there is a larger ratio of vertical sidewalls to conical sidewall then in the conical CCC depicted in FIG. 7.

The tests discussed below were made utilizing conical and standard CCCs with and without an interior heat insulating lining (not depicted). Such a lining can be positioned in the cone section of the CCC by spot welding or can be fitted therein friction tight.

### EXAMPLES

Test runs were conducted utilizing various sizes and configurations of the CCC of the present invention.

The parameters tested were as follows:
a. Separation efficiency, calculated as

$$x = \frac{{M}_{product}}{{M}_{feed}}$$

x-cyclone separation efficiency
M _{product}=amount of collected material in the bottom of the cyclone, kg
M _{feed}=amount of material fed to the cyclone, kg

In cyclones utilized in alumina processes high (preferably above 65%) separation efficiencies are desirable.
b. Heat capacity ratio (“H”), defined as the ratio of the heat capacity flow for the material relative to the gas. If H<1, gas is in excess; if H>1, material is in excess, according to the following formula:

$$H = \frac{{m}_{mat } {Cp}_{mat}}{{M}_{gas} {Cp}_{gas}}$$
H=heat capacity ratio; m ₘₐₜ=mass flow of inlet material, kg/s;
M _{gas}=mass flow of inlet gas, kg/s;
Cp ₘₐₜ=material average heat capacity from t _{mat,out} to t _{mat,in}, kcal/kg/K;
Cp _{gas}=gas average heat capacity from t _{gas,in} to t _{gas,out}, kcal/kg/K;
t=temperature; ₘₐₜ=material; _{gas}=gas;
_{in,out}=refers to, respectively, inlet and outlet temperatures of the counter current cyclone.
c. Thermal efficiency—the measure of the actual heat exchange. In the ideal case the figure is 100%, and if no heat at all is exchanged the figure will be 0%.

$$H \leq 1 \text{:} ∅ = \frac{{t}_{mat , in} - {t}_{mat , out}}{{t}_{gas , in} - {t}_{gas , out}}$$

$$H \geq 1 \text{:} ∅ = \frac{{t}_{gas , out} - {t}_{gas , in}}{{t}_{mat , in} - {t}_{gas , in}}$$

Thermal efficiencies in cyclones above 55% are desired in cyclones utilized in alumina processes.

The values set forth in the TABLE were observed for each of the cyclones tested:

TABLE

| Parameter Cyclone | | Standard | Standard | Conical | |
|---|---|---|---|---|---|
| Type | Unit | w/lining | wo/lining | wo/lining | Conical w/lining |
| Cyclone Size, Nom. | mm | 495 | 1500 | 1500 | 1500 |
| Dia. | | | | | |
| Capacity | MTPD | | 50-116 | 32-120 | 51-110 |
| Heat Capacity Flow | | 0.7-1.6 | 0.53-1.34 | 0.50-1.29 | 0.45-1.21 |
| Ratio | | | | | |
| Thermal Efficiency | % | 57-77 | 72.3-93.1 | 72.3-90.8 | 66.3-91.3 |
| Separation Efficiency | % | 90-97 | 93.9-99.7 | 93.2-99.7 | 86.3-94.7 |
| Inlet Air Velocity | m/sec | 24.0-25.2 | 15.5-34.0 | 25.0-26.7 | |
| Particle Breakdown | | | | | |
| 21 micron | % | 0.4 | 0.4-0.6 | 0.2-1.0 | 0.7-2.6 |
| 45 micron | % | 2.0 | 0.3-2.4 | 1.5-3.3 | 1.6-2.6 |

The tests indicate that, in general, the CCCs of the present invention showed results which were, for the most part, better than what would be expected to be realized in cyclones utilized in alumina processes.

Other embodiments of the invention will be apparent to those skilled in the art from a consideration of this specification or from practice of the invention disclosed. It is intended that the specification be considered as exemplary only, with the true scope and spirit of the invention being indicated by the following claims.

1. In a process for production of alumina from alumina trihydrate in which the trihydrate is calcined at an elevated temperature to form hot calcined alumina that is cooled in one or more stages, the improvement comprising in at least one stage cooling the hot calcined alumina in a countercurrent cyclone comprising a hollow housing including a generally cylindrical portion having a generally horizontal axis, said housing further including a first side wall defining a material inlet and a second side wall spaced from said first side wall and defining a gas outlet, said cyclone further comprising an inlet duct entering said cylindrical portion at a location spaced from said horizontal axis and a material exit spaced downwardly from said material inlet, said improvement further comprising feeding a cooling gas upwardly into said housing through said inlet duct, said housing forming said gas stream into a spiral vortex rotating around said horizontal axis, introducing hot calcined alumina into said spiral vortex through said material inlet, cooling said hot calcined alumina in said spiral vortex, discharging the cooled alumina through said material outlet, and discharging said gas through said gas outlet.

2. The process according to claim 1 wherein the hot alumina is introduced parallel in relation to the horizontal axis of the countercurrent cyclone and in such a manner that immediately on introduction the hot alumina possesses a tangential velocity component in relation to the axis of the countercurrent cyclone, and that this velocity component rotates in the same direction around the axis as the spirally-formed gas flow in which the hot alumina is transported.

3. The process of claim 1 wherein said alumina trihydrate is calcined at an elevated temperature of about 900-1500° C. and said cooled alumina has a temperature of between about 50° and 100° C.

4. The process of claim 1 wherein said material inlet is close to said horizontal axis.

5. The process of claim 1 wherein said gas outlet is close to said horizontal axis.

6. The process of claim 1 wherein said horizontal axis extends generally perpendicular to said first side wall and to said second side wall.

7. The process of claim 1 wherein said housing includes a generally cylindrical portion.

8. A process for the production of alumina from aluminium trihydrate, comprising (a) drying the aluminium trihydrate in a drying unit and thereafter preheating and partially calcining the dried aluminium trihydrate by contact with heated gas in a pre-heater, (b) separating the partially calcined aluminium trihydrate from the heated gas, (c) directing the separated aluminium trihydrate to a calciner, in which the aluminium hydrate is transformed into alumina at a temperature of approximately 900-1500° C. while suspended in a carrier gas, (d) directing the alumina into a primary cooler in which the alumina is cooled to a temperature of between about 180° and 300° C., said primary cooler being at least one countercurrent cyclone; and (e) introducing the cooled alumina material into a secondary cooler in which the temperature of the alumina material is reduced to between about 500 and 100° C.

9. The process according to claim 8 wherein the calciner is a gas suspension calciner.

10. The process according to claim 8 wherein the calciner is of the fluid bed type.

11. The process according to claim 8 wherein the alumina material, after it has passed out of the calciner and before it is directed into the primary cooler, is separated from the carrier gas.

12. A cyclone for cooling hot particulate matter comprising by contacting the hot particulate material with a cooling gas comprising:
a hollow housing generally cylindrical around a horizontal axis containing two opposing sidewalls, with a material inlet mounted in one side wall and a gas outlet mounted in the other sidewall, with both the material inlet and the gas outlet mounted close to the horizontal axis of the housing;
a gas inlet means for receiving said cooling gas as a gas stream which enters the gas inlet means and the housing in a upwardly direction, said gas inlet means mounted tangentially to said housing means, and said housing means mounted with said gas inlet means for cooperating therewith to form said gas stream into a gas vortex rotating around the horizontal axis,
a material discharge means for receiving material from said fluid vortex by operation of gravity; and
means for distributing material throughout the interior of the housing.

13. The cyclone of claim 12, wherein said means for distributing material includes a horizontally mounted baffle plate mounted adjacent to said material inlet means so that material entering the cyclone will collide with said baffle plate.

14. The cyclone of claim 12 further comprising means to regulate velocity of cooling gas entering the cyclone.

15. The cyclone of claim 14 wherein the regulating means includes a movable plate located within the cooling gas inlet which serves to adjust the size of the opening through which cooling gas will pass within the gas inlet.

16. The cyclone of claim 7 wherein said housing is generally cylindrical.
